(19) United States
(12) Patent Application Publication
(10) Pub. No.: US 2009/0269133 A1
(43) Pub. Date: Oct. 29, 2009

(54) LOCKING DEVICE FOR GRAPPLING LINKS

(75) Inventors: Edward Van Amelsfoort, Tilburg (NL); Joost Luyendijk, Rosmalen (NL)

Correspondence Address: Caterpillar Inc.;Intellectual Property Dept., AH 9510, 100 N.E. Adams Street, PEORIA, IL, 61629-9510, US

(73) Assignee: Caterpillar Work Tools B.V.

(21) Appl. No.: 12/431,840

(22) Filed: Apr. 29, 2009

(30) Foreign Application Priority Data
Apr. 29, 2008 (EP) 08155373.7

(51) Int. Cl. F16D 1/06; F16J 1/16

(52) U.S. Cl. 403/408.1; 403/154

(57) ABSTRACT

A locking device, in particular for a link of a grappler, comprises a movable pin provided with at least one groove, a locking plate to engage the groove and a holding element to hold the locking plate in the groove, wherein the engagement of the locking plate into the groove locks the pin. The invention also relates to a linking device comprising the locking device of the first aspect and a frame having spaced apart bushings to receive the pin. The invention further relates to a method of a method of locking a link of a grappler comprising the steps of providing a frame having spaced apart bushings, wherein at least one of the bushings carries a locking plate, threading a pin having a groove through the spaced apart bushings and engaging the locking plate into the groove.

### TECHNICAL FIELD

This disclosure relates to locking devices for links, particularly for link groups for connecting dangling grapplers to carrier machines and links for multi-processor jawsets.

### BACKGROUND

Dangling grapples, like scrap grapples, orange peel grapples, clamshell grapples, logging grapples and the like, may be connected to the stick of material carrier machines, excavators or material handler equipment by link groups, also known in the art as a crossheads. A link group may thus carry the grapple weight and the load generated by the payload.

Link groups may be provided with a movable main pin extending through parallel bushings to facilitate mounting and dismounting of a grapple from the stick of the material carrier machine. When a grapple is in a rest position, for instance lowered to the ground, the main pin may be removed from the link group, so that the stick of the machine may be detached from the grapple.

To expedite operations, especially during dismounting procedures, operators may choose not to extract the main pin completely from the link group but only to slide it through the bushings far enough to allow the stick to move away from the link group. However, special care must be taken not to remove the pin completely and further work and caution may be required to avoid inadvertently moving the link group in such a manner to cause the pin to fall out, hence slowing work procedures.

The same care must be taken when another grappler is connected to the stick of the machine. In this case, operators may insert the main pin back in the link group, carefully check the position of the main pin to verify that the main pin is fully inserted, and lock the main pin into place.

The above problems may be encountered also in multi-processor devices, which may consist of a standard housing and interchangeable jawsets for different demolition applications. The jawsets may be connected to the standard housing by three large pins: two pins in a static setup and a third pin in a dynamic setup. Each of these pins has to be removed or displaced to change from one jawset to the another and, again, efficiency in the work flow may be negatively affected if the pins are completely removed or fall out and time is consumed in carefully positioning and checking the position of the main pin when the main pin is pushed back into place.

The present disclosure is directed, at least in part, to improving or overcoming one or more aspects of prior systems.

### BRIEF SUMMARY OF THE INVENTION

In a first aspect, the present disclosure describes a locking device, in particular for a link of a grappler, comprising a movable pin provided with at least one groove, a locking plate to engage the groove and a holding element to hold the locking plate in the groove, wherein the engagement of the locking plate into the groove locks the pin.

In a second aspect, the disclosure describes a linking device comprising the locking device of the first aspect and a frame including spaced apart bushings to receive the pin.

In a third aspect, the disclosure describes a method of locking a link, particularly a link of a grappler, comprising the steps of providing a frame having spaced apart bushings, wherein at least one of the bushings carries a locking plate, threading a pin having a groove through the spaced apart bushings and engaging the locking plate into the groove.

Other features and advantages of the present disclosure will be apparent from the following description of various embodiments, when read together with the accompanying drawings.

### BRIEF DESCRIPTION OF THE DRAWINGS

FIG. 1 is an isometric view of an embodiment of a link for a grappler comprising a locking device according to the present disclosure;

FIG. 2 is a plan view of a main pin of the link for a grappler of FIG. 1;

FIG. 3 is a partial cross section view of the link coupled to a stick of a material carrier machine, in which the main pin is in a first locking position and the face of a locking plate is not visible;

FIG. 4 is a partial cross section view of the link, coupled to the stick of the material carrier machine, in which the main pin is partially inserted and the face of a locking plate is visible;

FIG. 5 is a partial cross section view of the link in which the main pin is in a second locking position and the face of a locking plate is not visible.

### DETAILED DESCRIPTION

This disclosure generally relates to locking devices for links of dangling grapples and links of jawsets of multi-processor devices.

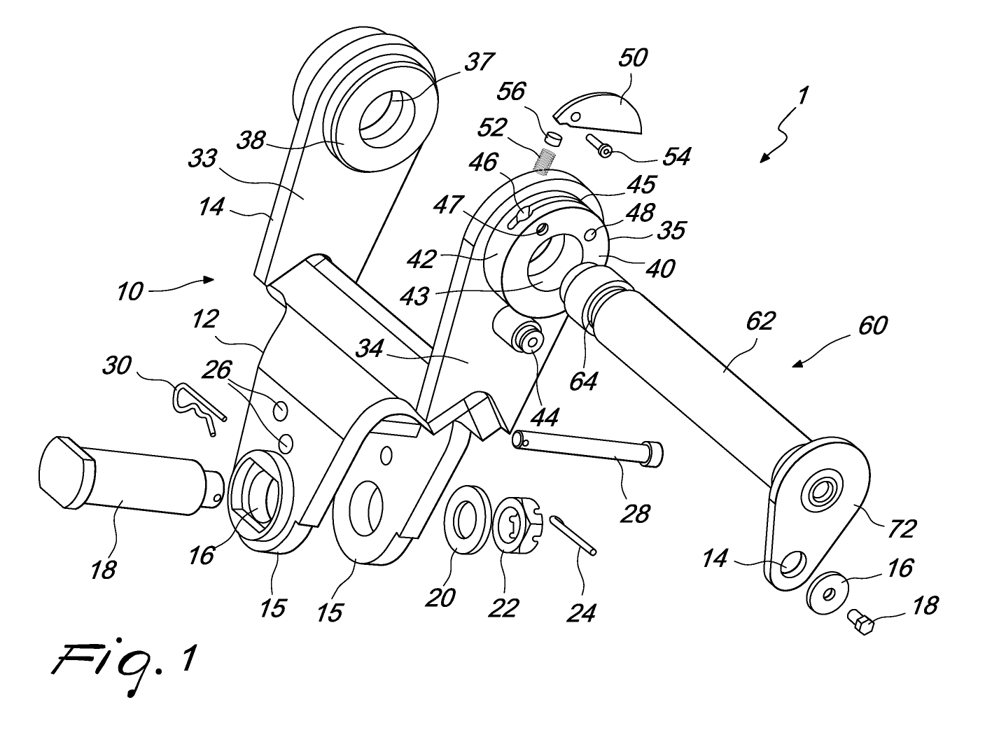

FIG. 1 illustrates an embodiment of a locking device for a link of a grappler (the grappler is not shown in the figures) according to the present disclosure.

A frame 10 of a link of a grappler may comprise a saddle 12 connected to a pair of arms 14. The saddle 12 may further comprise a pair of flanges 15, spaced apart for receiving a coupling portion of the grappler. Each flange 15 may have a guide hole 16. A grappler may be connected to the frame 10 by aligning the guide holes 16 to a corresponding hole in the coupling portion of the grappler and inserting a connecting pin 18 through the guide holes 16 and the corresponding hole in the grappler. A washer 20 and a nut 22 may be placed onto end of the inserted connecting pin 18 thereby connecting the saddle 12 to the grappler. A cotter 24 may further secure the connecting pin 18 to the saddle 12.

Each flange 15 of saddle 12 may further comprise a pair of holes 26 for receiving a lock pin 28. The lock pin 28 may be secured to the saddle 12 by a pin lock 30.

An end of each arm 14 may be connected to the saddle 12. A side of an arm 14 may face the corresponding side of the other arm 14. These sides of arms 14 are hereinafter referred to as inner sides 33 and, accordingly, the opposite side of each inner side 33 of an arm 14 is hereinafter referred to as outer side 34.

The free end of each arm 14 may carry a bushing 32. Bushing 32 may extend through arm 14 with openings on inner side 33 and outer side 34 of each arm. Bushings 32 of arms 14 may be substantially aligned.

On outer side 34 of an arm 14, a first outer boss 35 may circumvent the opening of the bushing 32. A second outer boss 36 may circumvent the opening of the bushing 32 on the outer side 34 of the other arm 14. Inner bosses 38 may be carried on the inner sides 33 around the openings of the bushings thereon. Outer bosses 35, 36 and inner bosses 38 may assist in extending the length of bushings 32 such that the openings of bosses 35, 36, 38 operate as openings of bushings 32. Adjacent first outer boss 35, on outer side 34, may be a threaded bushing 44. Threaded bushing 44 may be positioned between the first outer boss 35 and the end of arm 14 connected to saddle 12.

The first outer boss 35 may comprise a flat surface 40, an outer curved surface 42 and an inner curved surface 43. Outer curved surface 42 may include a slot 45. The opening of slot 45 may face the free end of arm 14 and may partially encircle the outer curved surface 42. At one end, slot 45 may widen to form a recess 46. Particularly, recess 46 may be positioned adjacent to said end of slot 45. Towards the opposite end, beyond recess 46, slot 45 may extend from the outer curved surface 42 through the first outer boss 35 to form an opening on the inner curved surface 43.

aperture 47 and an opening 48 may be located on flat surface 40. Aperture 47 and an opening 48 may be positioned adjacent to the slot 45. Aperture 47 may be located close to the end of slot 45 proximal to recess 46. Particularly, aperture 47 may be located towards the end of slot 45 such that the recess 46 is between aperture 47 and said end. Opening 48 may be located towards the opposite end of slot 45. Aperture 47 and opening 48 may extend from the flat surface 40 into first outer boss 35 to the cavity of slot 45 such that aperture 47 and opening 48 may be contiguous with slot 45.

A locking plate 49 may be provided, having size and shape suitable to fit into slot 45. In one embodiment, locking plate 49 may have a hemispherical shape with a curved edge 50 and a linear edge 51. The curvature of curved edge 50 may substantially correspond to the curvature of outer curved surface 42 of the first outer boss 35, such that at alignment of curved edge 50 with the outer curved surface 42 a substantially plane surface may be formed. At such alignment the linear edge 51 may project through the opening of slot 45 on the inner curved surface 43 of the first outer boss into bushing 32.

Locking plate 49 may comprise a face 52, which may be visible prior to insertion of locking plate 49 into slot 45 and alignment of curved edge 50 with the outer curved surface 42. On the other hand, at such alignment face 52 may be positioned within first outer boss 35 and may not be visible. Face 52 may thus function as an indicator to denote if the linear edge 51 is projecting into bushing 32. Face 52 may be visible when linear edge 51 is not projecting into bushing 32 and may not visible when linear edge 51 projects into bushing 32.

Face 52 may include a threaded hole 53. An end of locking plate 49 that may be configured into a rib 54 may be adjacent to threaded hole 53. Particularly, rib 54 may be formed by slanting of the linear edge on either side of the rib. More particularly, the rib may be chamfered.

A biasing element 55 may fit into recess 46 and may rest therein. The biasing element 55 may be of any suitable resilient material such as a spring. Rib 54 may abut and compress biasing element 55 upon insertion of locking plate 49 into slot 45. Biasing element 55 may push on locking plate 49. Locking plate 49 may be retained in the slot 45 by locking bolt 56.

Locking bolt 56 may be connected to locking plate 49 at threaded hole 53 through aligned aperture 47. In this connection, locking bolt 56 may also function as a pivot to the locking plate 49. Consequently, pushing action of the biasing element 55 on one end of the locking plate 49 may turn the locking plate 49 about locking bolt 56 to effect movement of the locking plate 49 into slot 45 and to effect projection of linear edge 51 through the opening of the slot 45 on the inner curved surface 43 of the first outer boss into the bushing 32. Particularly, the biasing element 55 may exert a sufficient force to pivot the locking plate 49 about 15 to 20 degrees.

A stud 58 may be positioned between the biasing element 55 and the locking plate 49. Stud 58 may effect an even distribution of the force exerted by the biasing element 55 onto the locking plate 49.

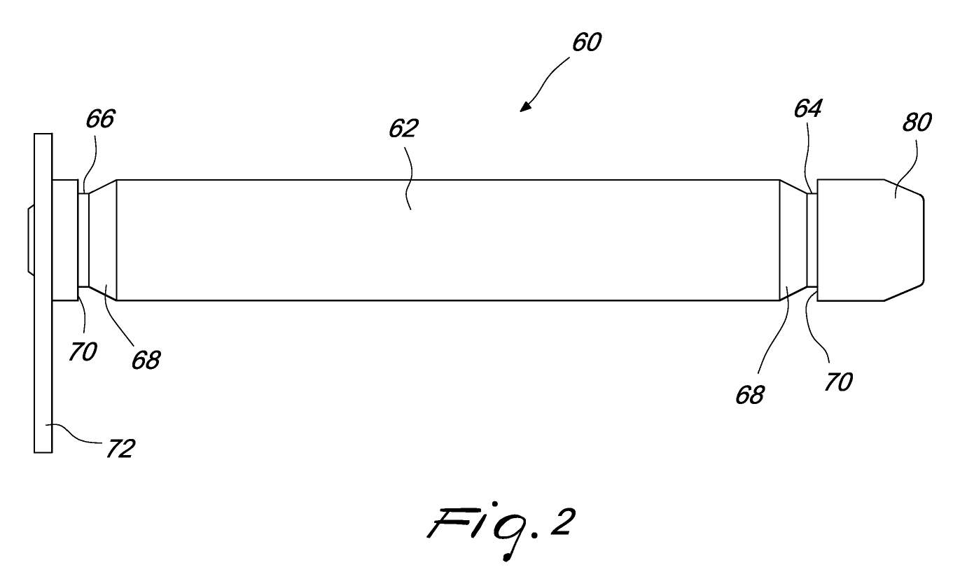

A main pin 60 may be provided for insertion through bushings 32 on arms 14. With reference to FIG. 2, main pin 60 may comprise a shank 62. The shank 62 may comprise a first groove 64 and a second groove 66. Each groove may include an oblique wall 68 and an upright wall 70. First groove 64 and the second groove 66 may be symmetrical and may be positioned on the shank 62 in an opposite orientation. Accordingly, the oblique walls 68 of grooves 64, 66 may face inwardly, with respect to the shank 62, towards each other. Upright walls 70 may face the ends of shank 62.

With the main pin 60 inserted into bushings 32, first groove 64 and second groove 66 may operate with the locking plate 49 to control the movement of the main pin 60 through bushings 32. Each groove 64, 66 may engage with locking plate 49 independently. Main pin 60 may be in a first locking position when the locking plate 49 is engaged in the first groove 64 and may be in a second locking position when the locking plate 49 is engaged in the second groove 64.

Pushing action of biasing element 55 on one end of the locking plate 49 may turn locking plate 49 about the locking bolt to effect movement of the locking plate into slot 45 and to effect projection of linear edge 51 into the bushing 32. Consequently, when the main pin 60 is inserted though the bushings 32, locking plate 49 may engage the shank 62 and the grooves 64, 66. Particularly, locking plate 49 may have a continues pressing engagement with the main pin 60. Such an engagement may be effected by the force exerted by the biasing element 55 on the locking plate 49.

The locking plate 49 may enter or exit either groove 64, 66 at the oblique wall 68 by sliding along said wall. Upright wall 70 may serve as an abutment surface to restrict movement of the locking plate out of the groove 64, 66 from said wall.

Main pin 60 may further comprise a locking flange 72 connected to one end of the shank 62. Locking flange 72 may be shaped as a tear drop and may carry a cavity 74. Main pin 60 may be fastened to an arm 14 by the locking flange 72. At complete insertion of the main pin 60 into bushings 32, the locking flange 72 may abut against first outer boss 35 and the threaded bushing 44 may project into the aligned cavity 74. A washer 76 and bolt 78 may be used to fasten the locking flange 72 to the arm 14. The opposite end of shank 62 may be a leading end 80 comprising a rim with a bevelled edge to ease insertion through the bushings 32.

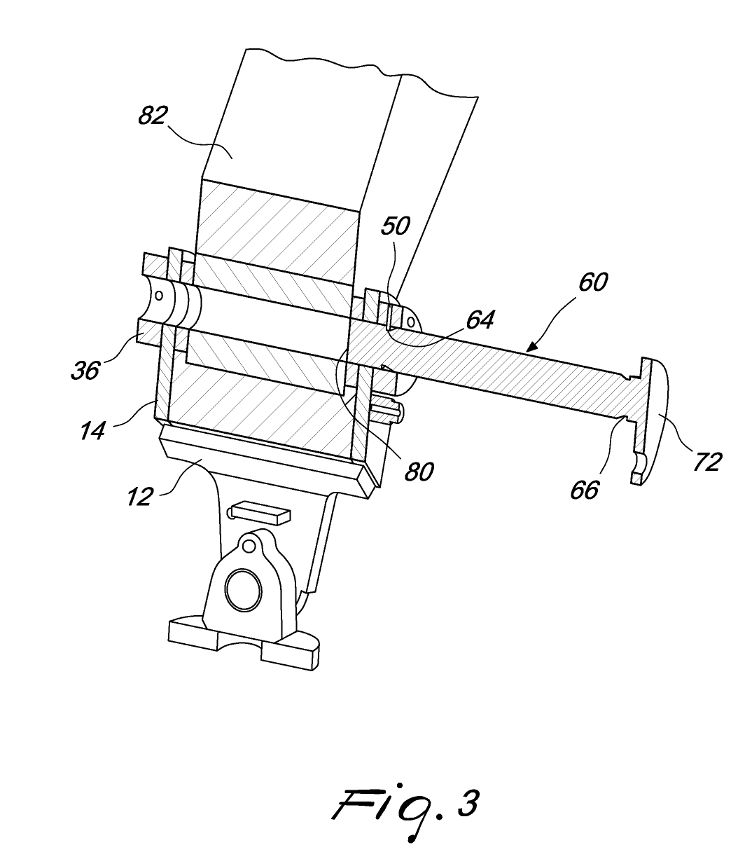

Operation of the device according the present disclosure will be now described with reference to FIGS. 3 through 5.

With reference to FIG. 3, the main pin 60 may be locked in the first locking position by the locking plate 49 engaging the first groove 64. Extraction of the main pin 60 out of the bushings 32 and frame 10 may be prevented by the abutment of the locking plate 49 with the upright wall 70 of the first groove 64. As the locking plate 49 is positioned in first groove 64, the face 52 of the locking plate 49 is not visible, indicating that the main pin 60 is locked in the first locking position. In this position, a stick 82 of the material carrier machined, having a passage 84, may be positioned between arms 14 of frame 10. Passage 84 may be aligned with the bushings 32 and stick 82 may be positioned for coupling with the arms 14.

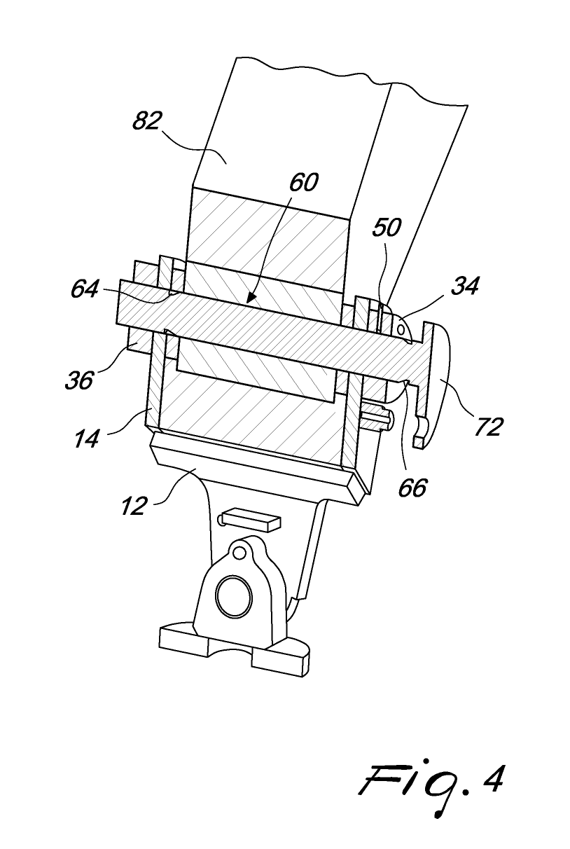

With reference to FIG. 4, the leading end 80 may be pushed though the bushing 32 of one arm 14 into passage 84. As the leading end 80 starts to move, the locking plate 49 may engage and slide along the oblique wall 68 out of first groove 64. Movement of locking plate 49 along oblique wall 68 and out of first groove 64 may push the locking plate 49 against the exerting force of biasing element 55 thereby turning the locking plate 49 about locking bolt, in the opposite direction, to effect movement of the locking plate 49 through the opening of the slot 45 on the inner curved surface 43 out of bushing 32. With the locking plate 49 positioned out of first groove 64, face 52 may be visible indicating that the main pin is not in a locking position. Face 52 may remain visible until the locking plate 49 is in a locking position.

Main pin 60 may be pushed with sufficient force to overcome the exerting force of the biasing element 55 and to effect movement of the locking plate 49 out of the first groove 64. If sufficient force is not exerted the locking plate 49 may slide back along oblique wall 68 into first groove 64.

The first locking position may be overridden by inserting a rod into opening 48 on flat face 40 of the first outer boss 35. The locking plate 49 may be held in a disengagement position by the rod thereby allowing the main pin to be completely removed from bushing 32. In the disengagement position the locking plate 49 may not be in contact with the shank 62.

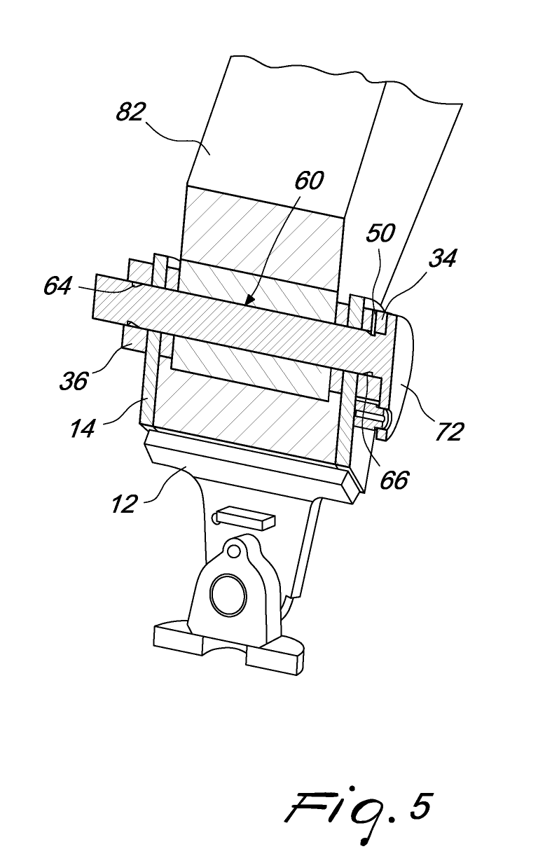

With reference to FIG. 5, the main pin 60 may be pushed through passage 84 into bushings 32 of the other arm 14. The main pin 60 may progress through the bushings 32 till locking plate 49 engages into second groove 66. Locking plate 49 may slide along oblique wall 68 into second groove 66. Further movement of the main pin 60 through bushings 32 may be prevented by the abutment of the locking plate 49 with the upright wall 70 of the second groove 66. With locking plate 49 in second groove 66 the face 52 of the locking plate 49 may not be visible indicating that the main pin 60 may be locked in the second locking position. In the second locking position first groove 64 may be positioned within second outer boss 36.

The skilled person will appreciate that the locking device according to the invention may be effected with one groove such that the main pin 60 is secured to arm 14 in the first locking position during mounting or dismounting of a link to a material carrier machine or changing of a grappler. Additionally, correct insertion of main pin 60 may be effected with one groove such that, in operation, the main pin 60 is secured to arm 14 in the second locking position.

The skilled in the art will also appreciate that holes in the main pin may be used instead of grooves and that locking plates may indicate pins or rods, to be used as indicators and locks, without departing from the disclosure.

The material used for constituting parts of the locking device may be metals, like steel or any other material having characteristics similar to such metals.

### INDUSTRIAL APPLICABILITY

This disclosure describes a locking device for locking devices for links of dangling grapples and links of jawsets for multi-processor devices. The main pin 60 is securely held in the bushing 32 by the locking pin 49 in the first locking position. Consequently, any inadvertent of the moving the frame 10 will not cause the main pin 60 to fall out. Dispensing with cautionary practices which may cause the main pin 60 to fall out increases efficiency of mounting or dismounting a link to a material carrier machine or changing of a grappler.

Particularly, locking the main pin 60 in the bushing 32 during maintenance procedures avoids the need to manually hold or support the main pin 60.

The industrial applicability of the locking device as described herein will have been readily appreciated from the foregoing discussion.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein.

Where technical features mentioned in any claim are followed by references signs, the reference signs have been included for the sole purpose of increasing the intelligibility of the claims and accordingly, neither the reference signs nor their absence have any limiting effect on the technical features as described above or on the scope of any claim elements.

One skilled in the art will realize the invention may be embodied in other specific forms without departing from the invention or essential characteristics thereof. The foregoing embodiments are therefore to be considered in all respects illustrative rather than limiting of the invention described herein. Scope of the invention is thus indicated by the appended claims, rather than the foregoing description, and all changes that come within the meaning and range of equivalence of the claims are therefore intended to be embraced therein.

1. A locking device, particularly for a link of a grappler, comprising:
a movable pin provided with at least one groove;
a locking plate to engage the groove; and
a holding element to hold the locking plate in the groove, wherein the engagement of the locking plate into the groove locks the pin.

2. The locking device according to claim 1 wherein the groove is displaced from one end of the pin in a first locking position of the pin.

3. The locking device according to claim 1 wherein the locking plate includes an indicator portion to signal disengagement of the locking plate from the groove.

4. The locking device according to claim 1 including a second groove displaced from the opposite end of the pin to lock the pin in a second locking position.

5. The locking device according to claim 4 wherein each groove circumvents the pin.

6. The locking device according to claim 5 wherein each groove has an oblique wall for sliding engagement of the pin with each groove.

7. The locking device according to claim 6 wherein each groove has an upright wall opposite the oblique wall for abutting engagement with the pin.

8. The locking device according to claim 4 wherein the grooves are symmetrical.

9. The locking device according to claim 1 wherein the holding element is a spring.

10. The locking device according to claim 9 wherein the spring is displaced to one end of the locking plate.

11. The locking device according to claim 9 including a stud positioned between the spring and the locking plate.

12. The locking device according to claim 9 wherein the locking plate has a continuous pressing engagement with the pin.

13. The locking device according to claim 1 wherein the locking plate is a hemispherical disc.

14. The locking device according to claim 1 including a frame having spaced apart bushings to receive the pin.

15. The locking device according to claim 14 including a boss having a hole to receive the locking plate and the holding element, the locking plate engaging with the pin through the hole.

16. The locking device according to claim 15 wherein the locking plate is pivotally connected to the boss.

17. A method of locking a link of a grappler comprising the steps of:
providing a frame having spaced apart bushings, wherein at least one of the bushings carries a locking plate;
threading a pin having a groove through the spaced apart bushings; and
engaging the locking plate into the groove.

18. The method according to claim 17 wherein the step of threading a pin includes providing a continuous pressing engagement between the locking plate and the pin.

19. The method according to claim 17 wherein the step of engaging the locking plate into the groove includes providing a sliding engagement between the locking plate and the groove.
